(19) United States
(12) Patent Application Publication
(10) Pub. No.: US 2003/0088459 A1
(43) Pub. Date: May 8, 2003

(54) Method of and apparatus for customer preference estimation

(75) Inventors: Koji Sato, Yokohama-shi (JP); Satoshi Okamoto, Fujisawa-shi (JP); Masayuki Takada, Isezaki-shi (JP); Noriyuki Abe, Yokohama-shi (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/287,597

(22) Filed: Nov. 5, 2002

(30) Foreign Application Priority Data
Nov. 8, 2001 (JP) 2001-343409

(51) Int. Cl. G06F 17/60

(52) U.S. Cl. 705/10

(57) ABSTRACT

In a method of customer preference estimation for estimating a customer preference with regard to a type of information to be provided, which is adopted in a system that provides a customer with various types of information in conformance to various information providing programs, information provision history data indicating information providing program selection method, the corresponding customer state and the customer response to the provided information are recorded each time information is provided to the customer. When the customer issues a new request for information, sets of history data indicating states similar to the customer's current state are extracted, the information providing program selection method used in conjunction with the history data indicating the best customer response among the extracted sets of history data is adopted, an information providing program is selected from a program database through the adopted selection method and information is provided to the customer in conformance to the selected information providing program.

### BACKGROUND OF THE INVENTION

1. Field of the Invention

The present invention relates to a method of and an apparatus for estimating customer preference and providing information that matches the customer preference.

2. Description of the Related Art

There is a method of customer preference estimation support in the related art (see Japanese Laid-Open Patent Publication No. 2000-132618) in which a preference of a customer is estimated by collecting information on the customer's product selection history and the customer preference thus estimated is used in electronic trade. In this method, a customer preference corresponding to a given product attribute is expressed as a numerical value based upon the customer's product selection history to estimate the degree of customer preference for a product.

### SUMMARY OF INVENTION

However, in the method of customer preference estimation in the related art described above, in which the customer preference is estimated entirely based upon information on the past product selection history of the customer who is the target of the preference estimation, no product selection history information can be obtained for a new customer, and thus, the preference of the new customer cannot be estimated. In addition, since the preference estimation is performed for an existing customer based upon past product selection history information alone, there is another problem in that the customer is never presented with any novel or fresh selection ideas.

An object of the present invention is to provide the customer with information matching his/her preference by estimating the customer preference that reflects a change occurring in the customer's state.

The method of customer preference estimation for estimating a customer preference with regard to a type of information to be provided according to the present invention, which is adopted in a system that provides a customer with various types of information in conformance to programs for providing various information, comprises recording in advance sets of information provision history data each indicating an information providing program selection method, a corresponding customer state and a customer response to provided information, extracting sets of history data indicating states similar to the customer's current state upon receiving a new request for information from the customer, adopting an information providing program selection method used in conjunction with history data indicating a best customer response among the extracted sets of history data, selecting an information providing program from a program database through the adopted selection method and providing information to the customer in conformance to the selected information providing program.

An apparatus for customer preference estimation that estimates a customer preference with regard to a type of information to be provided according to the present invention, used in a system that provides a customer with various types of information in conformance to programs for providing various information, comprises a recording device that records sets of information provision history data each indicating an information providing program selection method, a corresponding customer state and a customer response to provided information, a state acquisition device that ascertains the customer's current state when there is a new request for information issued by the customer, an extraction device that extracts sets of history data indicating states similar to the state ascertained by the state acquisition device from the history data recorded at the recording device and a program selection device that adopts an information providing program selection method used in conjunction with history data indicating a best customer response among the sets of history data extracted by the extraction device and selects an information providing program from a program database through the adopted selection method. The customer is provided with information in conformance to the information providing program selected by the program selection device.

### BRIEF DESCRIPTION OF THE DRAWINGS

FIG. 1 shows the structure assumed in an information providing system adopting the method of customer preference estimation according to the present invention in an embodiment;

FIG. 2 presents a flowchart of the customer preference estimation processing implemented in the embodiment;

FIG. 3 presents a flowchart of the selection processing executed in conformance to an information providing program in the embodiment; and

FIG. 4 presents a flowchart of the selection processing executed in conformance to an information providing program in an example of a variation.

### DETAILED DESCRIPTION OF PREFERRED EMBODIMENTS

An explanation is given on an example in which the present invention is adopted in a system that plays information obtained from a center system by using an information terminal mounted on a vehicle. It is desirable that the driver of the vehicle focus his attention entirely on the driving operation. For this reason, providing information by adopting the method of customer preference estimation according to the present invention in which information matching the customer preference is provided is an ideal system for the vehicle driver.

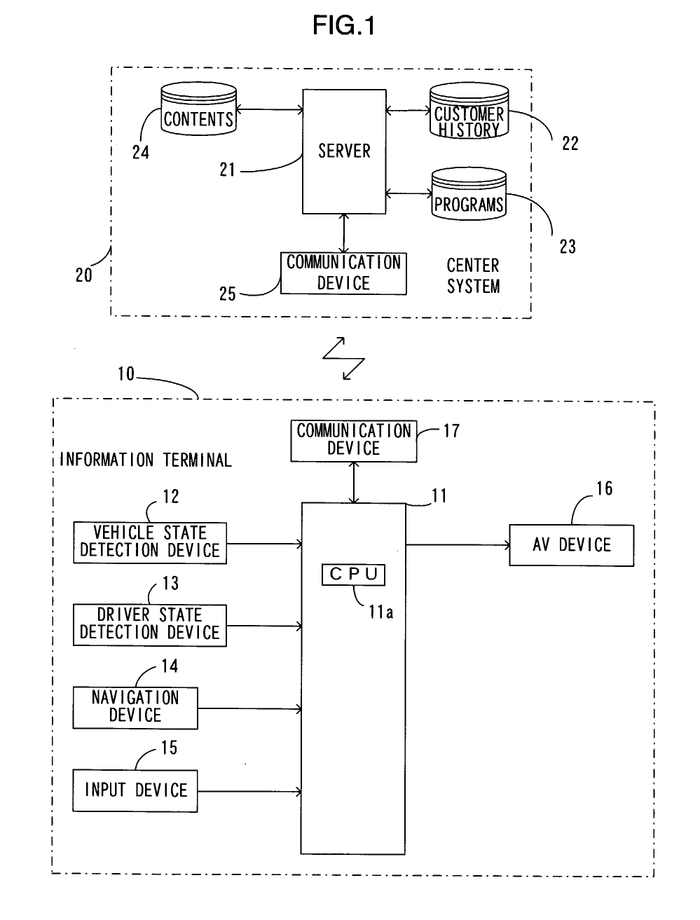

FIG. 1 shows the structure of an information providing system adopting the method of customer preference estimation according to the present invention achieved in an embodiment. The information providing system in the embodiment comprises an information terminal 10 and a center system 20. It is to be noted that while FIG. 1 shows only one information terminal 10, the system includes a plurality of similar information terminals 10.

The information terminal 10 includes a controller 11, a vehicle state detection device 12, a driver state detection device 13, a navigation device 14, an input device 15, an AV device 16, a communication device 17 and the like. The controller 11 is constituted of a CPU 11a and its peripheral components. The controller 11 accesses the center system 20 via the communication device 17, obtains the request information from the center system 20 and plays the obtained information at the AV device 16.

The vehicle state detection device 12, which includes various measuring instruments such as a vehicle speed sensor and a gearbox shift position sensor, detects the vehicle state. The driver state detection device 13, which includes various measuring instruments such as a sensor that detects whether or not the driver is seated and a camera that captures an image of the driver, detects the driver state. The navigation device 14 detects the current vehicle position through GPS (Global Positioning System) navigation or autonomous navigation. It also performs a search of a route to a destination whenever necessary and displays a roadmap, the route to the destination and the current position on a monitor at the AV device 16.

Through the input device 15, the driver inputs various types of information including the destination and numerous operations for the AV device 16 such as an information recording operation, an information playing operation, a screen operation and a volume adjustment operation are performed. The AV device 16, which includes a display unit such as an LCD (Liquid Crystal Display), an audio device such as a speaker and an information recording device such as a DVD (Digital Versatile Disk) device, records and plays information obtained from the center system 20 which may be images, music or other sound. It also displays the roadmap provided from the navigation device 14. The communication device 17 is utilized to perform wireless communication with the center system 20 either directly or via a mobile telephone.

At the center system 20, a server 21, a customer history database (hereafter referred to as a customer DB) 22, a program database (hereafter referred to as a program DB) 23, a contents database (hereafter referred to as a contents DB) 24, a communication device 25 and the like are installed. In the customer DB 22, information on previous requests made by each customer, the information providing programs used for the customer and the methods through which the information providing program was selected and the like are recorded in addition to attribute information such as the customer's age and gender. In the program DB 23, a plurality of information providing programs to be used to provide information are recorded. In the contents DB 24, various contents (various types of information) to be provided to the information terminals 10 are stored.

When there is a request for information from a customer (driver) through a specific information terminal 10, the server 21 obtains information on the current state of the customer from the information terminal 10. Then, the server 21 selects an information providing program based upon the history of the information provided to the customer in the past and the customer's current state and provides the information to the information terminal 10 in conformance to the selected information providing program.

Now, an explanation is given on the procedure implemented in the embodiment, through which the information is provided to the customer. The contents of the information provided from the center system 20 to a specific information terminal 10 is determined by the information providing program. The information providing program defines the category of information to be provided, the information source, and the specific procedure and the specific method through which the information is provided. Namely, by selecting a specific information providing program, an outline of the information being provided is determined. Accordingly, an optimal program is selected from the plurality of information providing programs stored in the program DB 23 in order to determine the outline of the information being provided.

There are numerous methods that may be adopted to select an information providing program. In the embodiment, the method of information providing program selection is determined based upon the history of the information provided to a given customer in the past and the customer's current state. In other words, during the procedure leading up to the actual information provision, the method of information providing program selection is first determined, then the optimal information providing program is selected through the selection method thus determined and the information is provided in conformance to the selected program.

Examples of programs selection methods are now explained. In a first method, from the various sets of information provided to the customer in the past that are included in history data, the information to which the customer responded most favorably is selected. In a second method, from history data of customers with similar attributes, i.e., the same gender, the same age group and similar interests, the information garnering the best customer response is selected. In a third method, the information garnering the best customer response in a state similar to the customer's current state is selected.

In this embodiment, the current state of the driver, i.e., the customer to be provided with information, is detected through the vehicle state detection device 12, the device state detection device 13, the navigation device 14, the input device 15 and the like.

The customer may be in any of the situations listed in Table 1, for instance.

TABLE 1

| | TIME AND | POSITION | POSITION | POSITION | TRAVELING | |
|---|---|---|---|---|---|---|
| ATTRIBUTES | DATE | INFORMATION 1 | INFORMATION 2 | INFORMATION 3 | SPEED | DESTINATION |
| | 1-4 | indoor | arterial road | urban area | 0 km/h | set |
| | 5-7 | outdoor | narrow street | suburban area | 1-10 km/h | not set |
| | 8-10 | | highway | | 11-40 km/h | |
| | 11-13 | | railroad | | 41-80 km/h | |
| | 14-16 | | | | 80˜km/h | |
| | 17-19 | | | | | |
| | 20-22 | | | | | |
| | 23-1 | | | | | |

In Table 1, the customer attributes include the time and the date at which information is to be provided, position information 1 that indicates whether the vehicle is indoors or outdoors, position information 2 indicating the type of road on which the vehicle is traveling, position information 3 indicating whether the vehicle is traveling in an urban area or a suburban area, information indicating the traveling speed, information indicating whether or not a destination has been set and the like. Among these attributes, the type of road on which the vehicle is currently traveling which is provided as position information 2 and the information as to whether the vehicle is currently traveling in an urban area or a suburban area which is provided as position information 3 are detected by the navigation device 14. In addition, the traveling speed is detected by the vehicle speed sensor (not shown) included in the vehicle state detection device 12. The information with regard to whether or not a destination has been set is detected based upon whether or not a destination setting operation has been performed through the input device 15. The customer's state includes at least one of the attributes listed in Table 1. In addition, these attributes are each measured in appropriate increments. For instance, the traveling speed is assigned to one of 5 levels, i.e., from 0 km/h through above 80 km/h.

In the embodiment, the customer (driver in this case) response to information provided from the center system 20 is classified into one of four stages, i.e., very good, good, satisfactory and poor, and is expressed as a numerical value. The customer response is determined based upon an input operation performed at the input device 15. For instance, if an operation to record the provided information is performed through the input device 15, the provided information is judged to be “very good” whereas if a repeat operation is performed at 15, the provided information is judged to be “good”. If an operation to simply play the provided information is performed, the provided information is judged to be “satisfactory” and if no operation is performed to play the provided information or if the playing operation is halted in the middle, the provided information is judged to be “poor”.

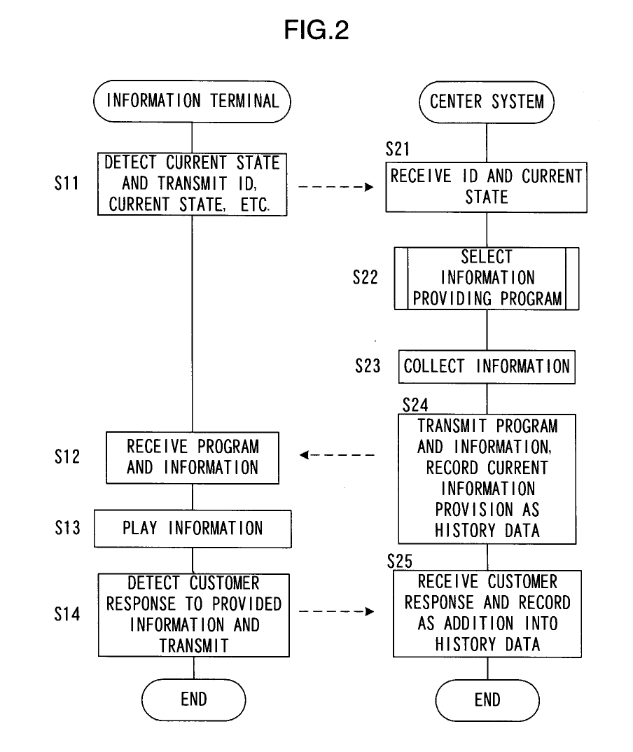

FIG. 2 presents a flowchart of the customer preference estimation processing implemented in the embodiment. The following is an explanation of the processing executed at an information terminal 10 and the processing executed at the center system 20, given in reference to the flowchart presented in FIG. 2.

As the customer performs an operation to request information through the input device 15 at the information terminal 10, the processing in step S11 and subsequent steps starts. In step 11, the controller 11 at the information terminal 10 detects the current state of the customer (the driver) (see Table 1) and transmits the detected state and the customer ID to the center system 20. The customer state is detected through the vehicle state detection device 12, the driver state detection device 13, the navigation device 14 and the input device 15 as explained earlier.

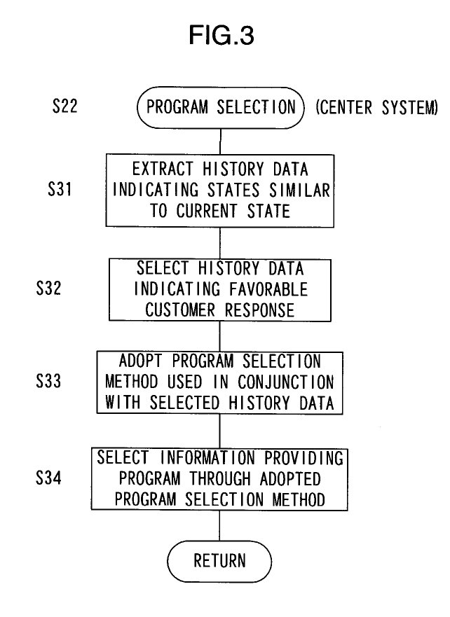

The center system 20 receives the customer ID and the customer state from the information terminal 10 in step S21 and then proceeds to step S22. In step S22, the center system 20 executes the information providing program selection processing shown in FIG. 3.

An explanation is now given on the information providing program selection process in reference to the flowchart presented in FIG. 3. In step S31, the center system 20 searches history data recorded in the customer history DB 22 and extracts a plurality of sets of history data indicating states similar to the customer's current state. It is to be noted that the similarity between the customer's current state and the state indicated in a given set of history data is expressed as a numerical value and history data with highest numerical values indicating high degrees of similarity are extracted. In the following step S32, customer response data in the extracted history data are checked and the history data indicating a favorable customer response are selected. Since each set of customer response data is expressed as a numerical value corresponding to one of the four levels as explained above, an integrated evaluation is made on the numerical values indicating the degrees of similarity to the customer's current state and the numerical values indicating various levels of customer responses and one set of history data is selected. In step S33, the information providing program selection method which was used in conjunction with the history data selected in step S32 is adopted. In step S34, the program DB 23 is searched through the selection method adopted in step S33 to select an information providing program. Once the information providing program is selected, the operation returns to step S23 in FIG. 2.

In step S23 in FIG. 2, information is collected from the contents DB 24 in conformance to the information providing program selected through the processing shown in the flowchart in FIG. 3. It is to be noted that the information source is not limited to the contents DB 24 at the center system 20 and information may be collected from all types of external information sources. In the following step S24, the collected information and the information providing program are transmitted to the information terminal 10. In addition, data related to the current information provision are recorded as history data into the customer history DB 22. In other words, the information providing program and the information that has been provided, the program selection method, the customer state according to which the selection method has been determined and the like are recorded.

In step S12, the information providing program and the information are received at the information terminal 10 from the center system 20. In step S13, which follows step S12, the information is played at the AV device 16 through the reproduction procedure which conforms to the information providing program.

In step S14, an information recording operation, a repeat operation, a playing operation, a provision halting operation or the like that is performed through the input device 15 is detected at the information terminal 10, and the customer response to the program and the information provided from the center system 20, which is expressed as a numerical value, is transmitted to the center system 20.

In step S25, the center system 20 receives the data indicating the customer response and transmitted in step S14 from the information terminal 10. The customer response data thus received are recorded as an addition to the current information provision history data recorded in the customer history DB 22 in step S24.

As described above, history data indicating states similar to the customer's current state are extracted from the customer history DB 22 and the history data having won the most favorable customer response are selected from the extracted history data. In addition, the program selection method used in conjunction with the selected history data is adopted, and an information providing program is selected from the program DB 23 through the adopted selection method. Then, information is collected in conformance to the selected program and the collected information is provided to the information terminal 10. As a result, it becomes possible to accurately estimate the customer preference which reflects any change in the customer state and, consequently, to provide the type of information best suiting the customer preference. (Another embodiment of the information providing program selection method)

In the embodiment described above, the history data indicating customer states similar to the customer's current state are extracted from the history data of the customer who has requested information. The following is an explanation of another embodiment in which the history data search is expanded to cover the history data of other customers with similar attributes to those of the customer who has requested information and history data indicating a customer state similar to the customer's current state are extracted. It is to be noted that since the processing is executed in a manner similar to that with which the processing in the preceding embodiment is executed except for the information providing program selection method adopted in this embodiment, the illustration and the explanation of the identical processing are omitted.

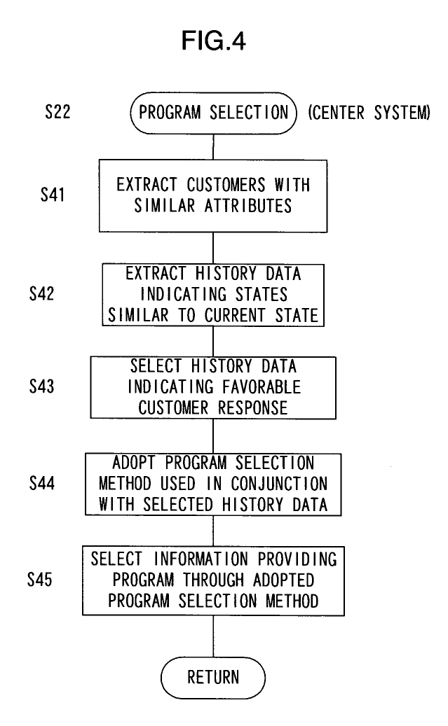

In step S22 in FIG. 2, the center system 20 executes the information providing program selection processing shown in FIG. 4 instead of the program selection processing shown in FIG. 3. In step S41 in FIG. 4, the center system 20 extracts customers with similar attributes to those of the customer who has requested the information from the customer history DB 22. In the following step S42, the history data recorded in the customer history DB 22 are searched and a plurality of sets of history data indicating states similar to the customer's current state of the customer who has requested information are extracted from the history data of the customer who has requested the information and also from the history data corresponding to the customers with similar attributes. It is to be noted that the similarity between the customer's current state and the state indicated by a given set of history data is expressed as a numerical value and history data with the highest numerical values indicating high degrees of similarity are extracted.

In the following step S43, customer response data in the history data extracted in step S42 are checked and the history data indicating a favorable customer response are selected. Since each set of customer response data is expressed as a numerical value corresponding to one of the four levels as explained above, an integrated evaluation is made on the numerical values indicating the degrees of similarity to the current customer state and the numerical values indicating levels of customer responses and one set of history data is selected. In step S44, the information providing program selection method which was used in conjunction with the history data selected in step S43 is adopted. In step S45, the program DB 23 is searched through the selection method adopted in step S44 to select an information providing program. Once the information providing program is selected, the operation returns to step S23 in FIG. 2.

In the other embodiment described above, the information providing program is selected through the following procedure. First, history data indicating states similar to the current state of the customer who has requested the information are extracted from the history data of the customer who has requested the information and the history data of customers with similar attributes. The information providing program selection method corresponding to the history data indicating a favorable customer response among the extracted history data is adopted and an information providing program is selected from the program DB 23 through the selection method thus adopted. As a result, novel and fresh information can be provided by making full use of a wider range of information provision history data. In addition, the preference of a new customer with no history data can be estimated to provide the new customer with suitable information.

It is to be noted that if the communication between the vehicle and the center system is to be achieved through a mobile telephone, the IMT—2000 (International Mobile Telecommunications—2000) method may be adopted instead of the PDC (Personal Digital Cellular) method or the GSM (Group System for Mobile Communications) method currently in wide use. The higher data transfer speed and the better sound quality made possible through the IMT—2000 method improve the quality of the information that is provided and the reliability of the information provision.

The above described embodiment is an example, and various modifications can be made without departing from the spirit and scope of the invention. For instance, information terminals utilized in the present invention are not limited to information terminals mounted in vehicles, and the present invention may be adopted in conjunction with information terminals that can be carried by people or information terminals internally provided in portable telephones or portable personal computers.

The disclosure of the following priority application is herein incorporated by reference: Japanese Patent Application No. 2001-343409 filed Nov. 8, 2001

What is claimed is;

1. A method of customer preference estimation for estimating a customer preference with regard to a type of information to be provided, which is adopted in a system that provides a customer with various types of information in conformance to programs for providing various information, comprising:
recording in advance sets of information provision history data each indicating an information providing program selection method, a corresponding customer state and a customer response to provided information;
extracting sets of history data indicating states similar to the customer's current state upon receiving a new request for information from the customer;
adopting an information providing program selection method used in conjunction with history data indicating a best customer response among the extracted sets of history data;
selecting an information providing program from a program database through the adopted selection method; and
providing information to the customer in conformance to the selected information providing program.

2. A method of customer preference estimation according to claim 1 wherein:
the customer state includes at least one of; date and time, current position, traveling speed and destination.

3. A method of customer preference estimation according to claim 1, wherein:
a customer response to the provided information is evaluated based upon an operation performed by the customer in response to the provided information.

4. A method of customer preference estimation according to claim 1 further comprising:
extracting other customers with similar attributes to attributes of the customer who has requested information from a customer database upon receiving a new request for information from the customer;
extracting sets of history data indicating states similar to the state of the customer who has requested information from the history data of the customer requesting the information and also from the history data of the other extracted customers;
adopting an information providing program selection method used in conjunction with history data indicating the best customer response among the extracted sets of history data;
selecting an information providing program from the program data base through the adopted selection method; and
providing information to the customer in conformance to the selected information providing program.

5. A method of customer preference estimation according to claim 1, wherein:
a portable telephone adopting an IMT-2000 method is utilized as a means for communication between a side that provides the information and a side that is provided with the information.

6. An apparatus for customer preference estimation that estimates a customer preference with regard to a type of information to be provided, used in a system that provides a customer with various types of information in conformance to various information providing programs, comprising:
a recording means for recording sets of information provision history data each indicating an information providing program selection method, a corresponding customer state and a customer response to provided information;
a state acquisition means for ascertaining the customer's current state when there is a new request for information issued by the customer;
an extraction means for extracting sets of history data indicating states similar to the state ascertained by the state acquisition means from the history data recorded at the recording means; and
a program selection means for adopting an information providing program selection method used in conjunction with history data indicating a best customer response among the sets of history data extracted by the extraction means and selects an information providing program from a program database through the adopted selection method, wherein:
information is provided to the customer in conformance to the information providing program selected by the program selection means.

7. An apparatus for customer preference estimation that estimates a customer preference with regard to a type of information to be provided, which is utilized in a system that provides the customer with various types of information in conformance to programs for providing various information, comprising:
a recording device that records sets of information provision history data each indicating an information providing program selection method, a corresponding customer state and a customer response to provided information;
a state acquisition device that ascertains the customer's current state when there is a new request for information issued by the customer;
an extraction device that extracts sets of history data indicating states similar to the state ascertained by the state acquisition device from the history data recorded at the recording device; and
a program selection device that adopts an information providing program selection method used in conjunction with history data indicating a best customer response among the sets of history data extracted by the extraction device and selects an information providing program from a program database through the adopted selection method, wherein:
information is provided to the customer in conformance to the information providing program selected by the program selection device.
